(19) United States
(12) Patent Application Publication
(10) Pub. No.: US 2014/0313326 A1
(43) Pub. Date: Oct. 23, 2014

(54) Method and system for providing an improved device user experience

(71) Applicant: Kadari Subbarao Sudeendra Thirtha Koushik, Bangalore (IN)

(72) Inventor: Kadari Subbarao Sudeendra Thirtha Koushik, Bangalore (IN)

(21) Appl. No.: 13/867,983

(22) Filed: Apr. 22, 2013

(51) Int. Cl. G09G 5/00

(52) U.S. Cl. CPC G09G 5/003
USPC 348/143

(57) ABSTRACT

A method and system for providing an improved device user experience. This embodiment relates to display devices, and more particularly to improving user experience of viewing display devices. The embodiments herein achieve an automatic way to optimize audio parameters, video parameters and system parameters of a device based on the distance between at least one user of the device and a screen of the device. The automatic parameters optimization is based on the user currently logged in and viewing the device.

The present application claims priority from Indian Application Number 346/CHE/2013, filed on 25 Jan. 2013, the disclosure of which is hereby incorporated by reference herein.

### TECHNICAL FIELD

This embodiment relates to display devices, and more particularly to improving user experience of accessing display devices.

### BACKGROUND

There are an increasing number of devices accessible to a user, which the user may use for accessing various media. Also, with such a proliferation of display devices, the time the user sends accessing such a device has also increased greatly. During the time the user is accessing the device, the user might not be likely to spend the entire time in the same position; he may perform movements due to a variety of reasons. These movements may be in the form of leaning back, leaning forward and so on. As a result of these movements, the ease of access of the device may suffer. For example, if the user leans back, his viewing angle with respect to the device changes and the screen of the device appears at less than optimum (the distortion may be in the form of a change in colours, colour temperature, contrast, less legible text and so on). So, the user has to manually adjust the device accordingly to regain the optimum access. This may prove to be an irritation, as the user has to manually adjust the device, almost every time the user makes a movement. Further, the user may be required to change the zoom to see the data clearer, every time the user moves further away from the screen. There are many issues associated with the movements of the users which may result in a deterioration of his viewing and listening experience.

There are modes on devices such as cameras which turn off the display on detecting that the user is in close proximity to the screen of the device. However, this is restricted to completely turning off the screen and does not perform any other sort of adjustment to the screen or the device.

There may be further issues such as potential harmful electromagnetic radiation emanating from the device increasing as the user moves closer to the device (the electromagnetic radiation may be from wireless communication networks such as Bluetooth, Wi-Fi and so on). Currently, the user may have the option of adjusting the strength of the radiation emanating from his device, but this process of adjusting is not very intuitive and may be buried in an option in a not very easily accessible location.

### SUMMARY

Accordingly the embodiment provides a method for enabling at least one user to access a device, the method comprising of adjusting at least one setting of the device in an automatic manner by the device, on detecting a relative motion between at least one user currently accessing the device and the device.

Also, disclosed herein is a device configured for enabling at least one user to access the device, the device further configured for adjusting at least one setting of the device in an automatic manner, on detecting a relative motion between at least one user currently accessing the device and the device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This embodiment is illustrated in the accompanying drawings, through out which like reference letters indicate corresponding parts in the various figures. The embodiments herein will be better understood from the following description with reference to the drawings, in which:

FIGS. 1a and 1b depict a device being used by one user and a plurality of users for accessing data respectively, according to embodiments as disclosed herein;

FIG. 2 depicts a device with a screen, which enable at least one user to access media, according to embodiments as disclosed herein;

FIG. 3 is a flowchart illustrating the process of adjusting the settings of a device based on the position of a user, according to embodiments as disclosed herein; and

FIG. 4 is a flowchart depicting the process of adjusting the settings of a device based on the position of a user, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

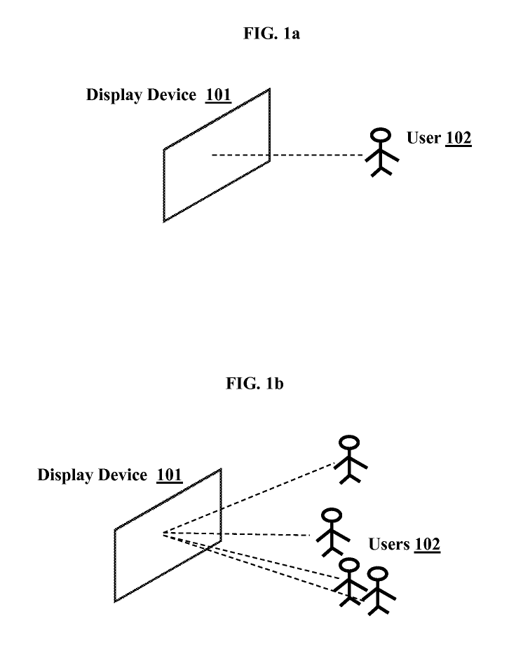

The embodiments herein achieve an automatic way to optimize audio parameters, video parameters and system parameters of a device based on the distance between at least one user of the device and a screen of the device. Referring now to the drawings, and more particularly to FIGS. 1 through 4, where similar reference characters denote corresponding features consistently throughout the figures, there are shown preferred embodiments.

FIGS. 1a and 1b depict a device being used by one user and a plurality of users for accessing data respectively, according to embodiments as disclosed herein.

FIG. 1a depicts a device being used by one user. The device 101 may be a Television, a mobile phone, a tablet, a laptop, a computer, a portable media player (such as a music player, a DVD player, a CD player and so on) or any other device which enables the user 102 to aces data using the device. The data which may be accessed may comprise of media (such as a combination of one or more of video, audio and text), a document (such as a presentation, a write-up, a paper and so on), a television program or any other form of data which may be accessed on a device 101 with a screen.

When the user 102 starts the device 101, the device 101 may measure the current position of the user 102 with respect to the screen of the device 101. The device 101 may measure the current position of the user 102 using a suitable means such as but not limited to infrared based means, a camera and so on. The current position of the user 102 may comprise of the distance between the user 102 and the screen, the angle of the user 102 with respect to the screen and so on. Based on the position of the user 102, the device 101 adjusts the settings of the device.

In an embodiment herein, the user 102 may setup an account on the device 101 and setup default settings in terms of his normal position with respect to the screen of the device 101. On starting the device 101, the user 102 logs in to his account and the device 101 loads his default settings. The user 102 may configure the default settings at any point in time.

The device 101 monitors the user 102 and on detecting a movement of the user 102 with respect to the screen adjusts the settings of the device accordingly. The movement may be the relative motion of the user with respect to the screen, wherein the movement may be performed by the user or may be a change in position of the device. The device 101 may monitor the user 102 with respect to the screen of the device using a suitable means such as but not limited to infrared based means, a camera and so on. The device 101 may monitor the user 102 in a continuous manner or at periodic intervals, wherein the periodic intervals may be configured by the user 102. The settings of the device that may be adjusted may comprise of brightness, contrast, sharpness, colour temperature, tint of the screen. The settings of the device that may be adjusted may comprise of the font size of any text present on the screen, zoom size of the media present on the screen and so on. The settings of the device that may be adjusted may comprise of audio signal strength (on at least one of the speakers and the headphones), sensitivity of a camera associated with the device 101. The settings of the device that may be adjusted may further comprise of the strength of wireless signals emanating from the device 101, such as Bluetooth signals, Wi-Fi signals and so on.

FIG. 1b depicts a device being used by a plurality of users for accessing data. The device 101 may be a Television, a mobile phone, a tablet, a laptop, a computer, a portable media player (such as a music player, a DVD player, a CD player and so on) or any other device which enables the users 102 to aces data using the device. The data which may be accessed may comprise of media (such as a combination of one or more of video, audio and text), a document (such as a presentation, a write-up, a paper and so on), a television program or any other form of data which may be accessed on a device 101 with a screen.

When at least one of the users 102 starts the device 101, the device 101 may measure the current position of the users 102 with respect to the screen of the device 101. The device 101 may measure the current position of the users 102 using a suitable means such as but not limited to infrared based means, a camera and so on. The device 101 may perform facial recognition to recognize the number of faces presently accessing the device. The current position of the users 102 may comprise of the average distance between the users 102 and the screen, the average angles of the user 102 with respect to the screen and so on. The device 101 may also consider the optimum angle for viewing the screen based on the current locations of the users 102 with respect to the screen and may optimize the settings of the device to maximize the comfort of all the users 102. Further, the device 101 may consider the number of users accessing the device, while adjusting the device 101.

In an embodiment herein, the users 102 may setup a group profile account on the device 101 and setup default settings in terms of the normal position with respect to the screen of the device 101 for the current group of users 102. On starting the device 101, at least one of the users 102 logs in to this account and the device 101 loads the default settings for this specific group. The users 102 may configure the default settings at any point in time.

In another embodiment herein, the device 101 may consider the user profile of a user who has currently logged in and adjust the settings of the device, as per the profile.

The device 101 monitors the users 102 and on detecting a movement on the part of the users 102 with respect to the screen adjusts the settings of the device accordingly. The movement may be the relative motion of the user with respect to the screen, wherein the movement may be performed by the user or may be a change in position of the device. The device 101 may monitor the users with respect to the screen of the device using a suitable means such as but not limited to infrared based means, a camera and so on The device 101 may monitor the users 102 in a continuous manner or at periodic intervals, wherein the periodic intervals may be configured by at least one of the users 102. The settings of the device that may be adjusted may comprise of brightness, contrast, sharpness, colour temperature, tint of the screen. The settings of the device that may be adjusted may comprise of the font size of any text present on the screen, zoom size of the media present on the screen and so on. The settings of the device that may be adjusted may comprise of audio signal strength (on at least one of the speakers and the headphones), sensitivity of a camera associated with the device 101. The settings of the device that may be adjusted may further comprise of the strength of wireless signals emanating from the device 101, such as Bluetooth signals, Wi-Fi signals and so on.

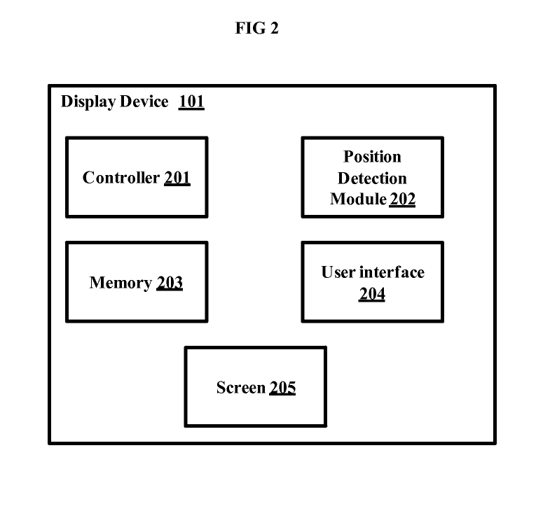

FIG. 2 depicts a device with a screen, which enable at least one user to access media, according to embodiments as disclosed herein. The device 101 comprises of a controller 201, a position detection module 202, a memory 203, a user interface 204 and a screen 205.

When the user 102 starts the device 101, the controller 201 instructs the position detection module 202 to measure the current position of the user 102 with respect to the screen of the device 101. The position detection module 202 measures the current position of the user 102. The position detection module 202 may measure the current position of the user 102 using a suitable means such as but not limited to infrared based means, a camera and so on. The position detection module 202 may measure the current position of the user 102 in terms of the distance between the user 102 and the screen, the angle of the user 102 with respect to the screen and so on. Based on the position of the user 102 as detected by the position detection module 202, the controller 201 adjusts the settings of the device. The controller 201 may adjust the settings related to the screen 205 such as brightness, contrast, sharpness, colour temperature, tint and so on. The controller 201 may also adjust settings of the device such as the font size of any text present on the screen, zoom size of the media present on the screen and so on. The controller 201 may also adjust the audio properties of the device 101 such as the audio signal strength (on at least one of the speakers and the headphones) and the camera related settings (such as the sensitivity of a camera associated with the device 101 and so on). The controller 201 may also adjust the strength of wireless signals emanating from the device 101, such as Bluetooth signals, Wi-Fi signals and so on.

In an embodiment herein, the controller 201 may enable the user 102 to setup an account using the user interface 204 and setup default settings in terms of his normal position with respect to the screen 205. The controller 201 may store the settings in a suitable location such as the memory 203. The controller 201 may also store the settings in a location external to the device, such as in an external storage disk, a database, a remote server and so on. On starting the device 101, the controller 201 enables the user 102 to log in to his account using the user interface 204 and the controller 201 loads his default settings from the storage location. The controller 201 may enable the user 102 to configure the default settings at any point in time, which the controller 201 may update in the storage location.

The controller 201 with the assistance of the position detection module 202 monitors the user 102. On the position detection module 202 detecting a movement on the part of the user 102 with respect to the screen of the device, the position detection module 202 informs the movement to the controller 201. The position detection module 202 may also inform about the nature and degree of the movement of the user with respect to the screen to the controller 201. The information from the position detection module 202 to the controller may comprise of information such as if the relative position of the user with respect to the screen is away/towards the screen 205 and so on. The controller 201 checks if the relative motion of the user with respect to the screen is above a threshold, wherein the threshold may set by the user 102. If the relative motion of the user 102 is above the threshold, the controller 201 adjusts the settings of the device 101 accordingly. The device 101 may monitor the user 102 using a suitable means such as but not limited to infrared based means, a camera and so on. The controller 201 may configure the position detection module 202 to monitor the user 102 in a continuous manner or at periodic intervals, wherein the controller 201 enables the user 102 to configure the periodic intervals.

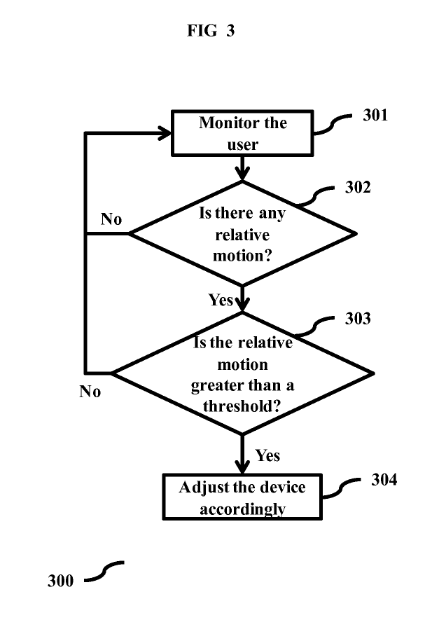

FIG. 3 is a flowchart illustrating the process of adjusting the settings of a device based on the position of a user, according to embodiments as disclosed herein. The device 101 monitors (301) the relative position of the user 102 with respect to the screen of the device. The device 101 may monitor the relative position of the user 102 using a suitable means such as but not limited to infrared based means, a camera and so on. The device 101 may configure the device 101 to monitor the user 102 in a continuous manner or at periodic intervals, wherein the device 101 enables the user 102 to configure the periodic intervals. On the device 101 detecting (302) a relative motion between the user 102 and the screen of the device 101, the device 101 checks (303) if the relative motion is above a threshold, wherein the threshold may set by the user 102. If the relative motion is above the threshold, the device 101 adjusts (304) the settings of the device 101 accordingly. The various actions in method 300 may be performed in the order presented, in a different order or simultaneously. Further, in some embodiments, some actions listed in FIG. 3 may be omitted.

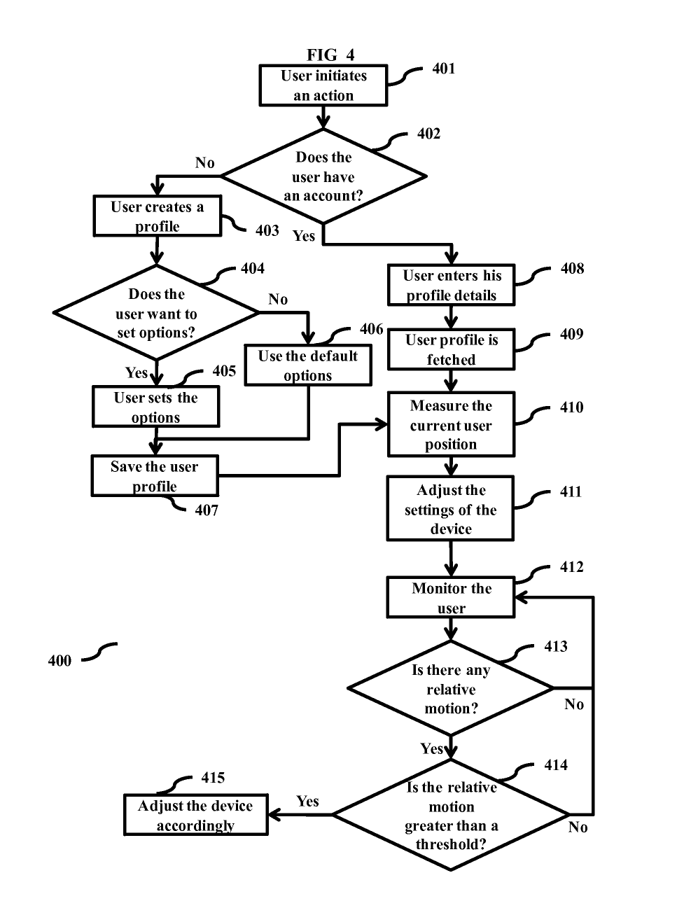

FIG. 4 is a flowchart depicting the process of adjusting the settings of a device based on the position of a user, according to embodiments as disclosed herein. When the user 102 initiates (401) an action related to the device 101, the device 101 checks (402) if the user 102 has a user account. The action initiated by the user 102 may comprise of the user 102 starting the device 101, the user 102 initiating access to a media and so on. If the user 102 does not have a user account, the device 101 enables the user 102 to create (403) a user account. The device 101 checks (404) if the user 102 wants to set his preferences. If the user 102 does not want to set preferences, the device 101 considers (406) the default preferences for the user account. If the user 102 wants to set preferences, the user sets (405) the preferences. The device 101 then saves (407) the user profile. If the user 102 has a user account, the user 102 enters (408) his account details such as his login ID and his password. The device 101 fetches (409) the user preferences from the storage location. The device estimates (410) the current position of the user 102 with respect to the screen of the device 101. The device 101 may measure the current position of the user 102 in terms of the distance between the user 102 and the screen, the angle of the user 102 with respect to the screen and so on. Based on the position of the user 102 as detected by the device 101, the device 101 adjusts (411) the settings of the device. The device 101 may adjust the settings related to the device 101 such as brightness, contrast, sharpness, colour temperature, tint and so on. The device 101 may also adjust settings of the device such as the font size of any text present on the screen, zoom size of the media present on the screen and so on. The device 101 may also adjust the audio properties of the device 101 such as the audio signal strength (on at least one of the speakers and the headphones) and the camera related settings (such as the sensitivity of a camera associated with the device 101 and so on). The device 101 may also adjust the strength of wireless signals emanating from the device 101, such as Bluetooth signals, Wi-Fi signals and so on. The device 101 (412) monitors the relative position of the user 102 with respect to the screen of the device. The device 101 may monitor the user 102 using a suitable means such as, but not limited to infrared based means, a camera and so on. The device 101 may monitor the user 102 in a continuous manner or at periodic intervals, wherein the device 101 enables the user 102 to configure the periodic intervals. On the device 101 detecting (413) a relative motion between the user and the screen of the device, the device 101 checks (414) if the relative motion is above a threshold, wherein the threshold may set by the user 102. If the relative motion is above the threshold, the device 101 adjusts (415) the settings of the device 101 accordingly. The various actions in method 400 may be performed in the order presented, in a different order or simultaneously. Further, in some embodiments, some actions listed in FIG. 4 may be omitted.

Consider an example where the user 101 is watching a video on a handheld device. The handheld device monitors the user in a continuous manner and on detecting that the user 101 has moved closer to the handheld device, the handheld device lowers the audio volume and lowers the camera sensitivity. The handheld device further reduces the signal strength of Wi-Fi and Bluetooth, so as to prevent the user 101 from receiving an excess dose of radiation from the signals. The handheld device further adjusts the screen so as to retain the optimum viewing experience for the user.

Embodiments herein enable an optimum media access experience for the user in an automatic manner, with the user able to take natural, comfortable positions without compromising on the user experience. Embodiments herein enable an easy on the eye viewing experience and provide comfort even for viewers with spectacles.

Embodiments herein enable a reduction in health risks associated with wireless signal radiations by reducing such signals when the user is closer to the screen of the device.

Embodiments disclosed herein link the adjustments to the profiles of the users who has logged in, so the device when used by multiple people will ensure personalized optimization of experience.

Embodiments disclosed herein optimize the viewing experience for the user in terms of audio, visual and system level parametric adaptation. This allows the user to take comfortable positions while watching a device and adapts the device accordingly to render the best possible experience every time. This is not a one-dimensional optimization but multidimensional optimization.

Embodiments disclosed herein can lead to energy and savings due to optimal use of energy by the device.

The embodiments disclosed herein can be implemented through at least one software program running on at least one hardware device and performing network management functions to control the network elements. The network elements shown in FIGS. 1 and 2 include blocks which can be at least one of a hardware device, or a combination of hardware device and software module.

Embodiments disclosed herein optimize the viewing experience for the user in terms of audio, visual and system level parametric adaptation. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for enabling at least one user to access a device, the method comprising of
Adjusting at least one setting of the device in an automatic manner by the device, on detecting a relative motion between at least one user currently accessing the device and the device.

2. The method, as claimed in claim 1, wherein the device monitors the at least one user in a continuous manner for detecting relative motion between the user and the device.

3. The method, as claimed in claim 1, wherein the device monitors the at least one user at periodic intervals for detecting relative motion between the user and the device.

4. The method, as claimed in claim 1, wherein the method further comprises of
checking if the relative motion between the user and the device.is above a threshold; and
adjusting the settings of the device, if the motion of the user is above the threshold.

5. The method, as claimed in claim 1, wherein the at least one setting of the device comprises of brightness of screen of the device; contrast of the screen of the device; colour temperature of the screen of the device; tint of the screen of the device; font size of text on the screen of the device; zoom of the media present on the screen; audio signal strength of the device; sensitivity of camera present on the device; and strength of wireless signals emanating from the device.

6. The method, as claimed in claim 1, wherein the settings are adjusted by the device depending on the nature of relative motion between the user and the device.

7. The method, as claimed in claim 1, wherein the method further comprises of
logging into an account by the at least one user using the device, at time of accessing the device; and
fetching profile of the user from the account by the device, on the user logging into the device.

8. The method, as claimed in claim 7, wherein the method further comprises of the user updating the account at any point in time.

9. A device configured for enabling at least one user to access the device, the device further configured for
Adjusting at least one setting of the device in an automatic manner, on detecting a relative motion between at least one user currently accessing the device and the device.

10. The device, as claimed in claim 9, wherein the device is configured for monitoring the at least one user in a continuous manner for detecting relative motion between the user and the device.

11. The device, as claimed in claim 9, wherein the device is configured for monitoring at least one user at periodic intervals for detecting relative motion between the user and the device.

12. The device, as claimed in claim 9, wherein the device is configured for
checking if the relative motion between the user and the device of the user is above a threshold; and
adjusting the settings of the device, if the relative motion between the user and the device is above the threshold.

13. The device, as claimed in claim 9, wherein the device is configured for changing the at least one setting of the device comprising of brightness of screen of the device; contrast of the screen of the device; colour temperature of the screen of the device; tint of the screen of the device; font size of text on the screen of the device; zoom of the media present on the screen; audio signal strength of the device; sensitivity of camera present on the device; and
strength of wireless signals emanating from the device.

14. The device, as claimed in claim 9, wherein the device is configured for adjusting the settings depending on the nature of relative motion between the user and the device.

15. The device, as claimed in claim 9, wherein the device is configured for
logging into an account by at least one user using the device, at time of accessing the device; and
fetching profile of the user from the account, on the user logging into the device.

16. The device, as claimed in claim 15, wherein the device is configured for enabling the user to update the account at any point in time.
